(19) United States
(12) Patent Application Publication
(10) Pub. No.: US 2020/0392897 A1
(43) Pub. Date: Dec. 17, 2020

(54) Variable Engine Inlet Geometry Algorithm

(71) Applicant: Bell Helicopter Textron Inc., Fort Worth, TX (US)

(72) Inventor: Thomas Dewey Parsons, Fort Worth, TX (US)

(73) Assignee: Bell Helicopter Textron Inc., Fort Worth, TX (US)

(21) Appl. No.: 16/440,193

(22) Filed: Jun. 13, 2019

(51) Int. Cl. F02C 7/042; B64D 33/02; G07C 5/08

(52) U.S. Cl. CPC F02C 7/042; B64D 2033/0253; G07C 5/0841; B64D 33/02

(57) ABSTRACT

Embodiments are directed to systems and methods for determining an optimal engine inlet area to minimize spillage drag. An algorithm may utilize aircraft parameters, aircraft performance charts, and engine models to determine the engine inlet area as a function of engine air mass flow, airspeed, and air density at current ambient conditions.

### BACKGROUND

Spillage drag occurs when an aircraft engine receives more airflow at its inlet than the engine's compressor can ingest at a given power setting. This causes excess airflow to spill back out of the engine inlet into the free stream air and results in a drag penalty. This can result in significant spillage drag in some flight conditions, particularly at high speeds. This phenomenon becomes more problematic with increasing airspeed.

### SUMMARY

Embodiments are directed to systems and methods for controlling aircraft engine inlet geometry. A flight control computer or similar system may determine a required engine power based upon current aircraft parameters, determine a desired engine air mass flow based upon the required engine power, calculate an optimum engine inlet area based upon the desired engine air mass flow, a current airspeed, and an air density, and provide a command to one or more actuators to adjust the aircraft engine inlet to conform to the calculated optimum engine inlet area. The optimum engine inlet area is calculated to cause minimum spillage drag and thereby optimize aircraft performance.

The aircraft parameters may comprise one or more of outside air temperature, altitude, airspeed, and humidity. The required engine power may be determined from aircraft performance chart data. The desired air mass flow may be determined from engine performance model data. The flight control computer may further determine a relationship between air mass flow and airspeed based upon the aircraft performance chart data and the engine performance model data.

In a tiltrotor aircraft, the flight control computer may determine a current engine inlet angle, then calculate the engine inlet area based upon the current engine inlet angle, and/or adjust the command to the one or more actuators based upon the current engine inlet angle.

### BRIEF DESCRIPTION OF THE DRAWINGS

Having thus described the invention in general terms, reference will now be made to the accompanying drawings, which are not necessarily drawn to scale, and wherein:

FIG. 1 illustrates a tiltrotor aircraft in a helicopter mode wherein the proprotors are positioned substantially vertical for use with certain embodiments.

FIG. 2 illustrates the tiltrotor aircraft of FIG. 1 in an airplane mode wherein the proprotors are positioned substantially horizontal.

FIG. 3 illustrates a case in which a high mass of inlet airflow is required by an engine.

FIG. 4 illustrates a case in which a low mass of inlet airflow is required by the engine.

FIG. 5 illustrates an engine with intake walls that are configured to ingest an optimal mass of airflow.

FIG. 6 is a flowchart illustrating an algorithm for adjusting engine inlet geometry based upon flight conditions according to an example embodiment.

While the system of the present application is susceptible to various modifications and alternative forms, specific embodiments thereof have been shown by way of example in the drawings and are herein described in detail. It should be understood, however, that the description herein of specific embodiments is not intended to limit the system to the particular forms disclosed, but on the contrary, the intention is to cover all modifications, equivalents, and alternatives falling within the spirit and scope of the present application as defined by the appended claims.

### DETAILED DESCRIPTION

Illustrative embodiments of the system of the present application are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

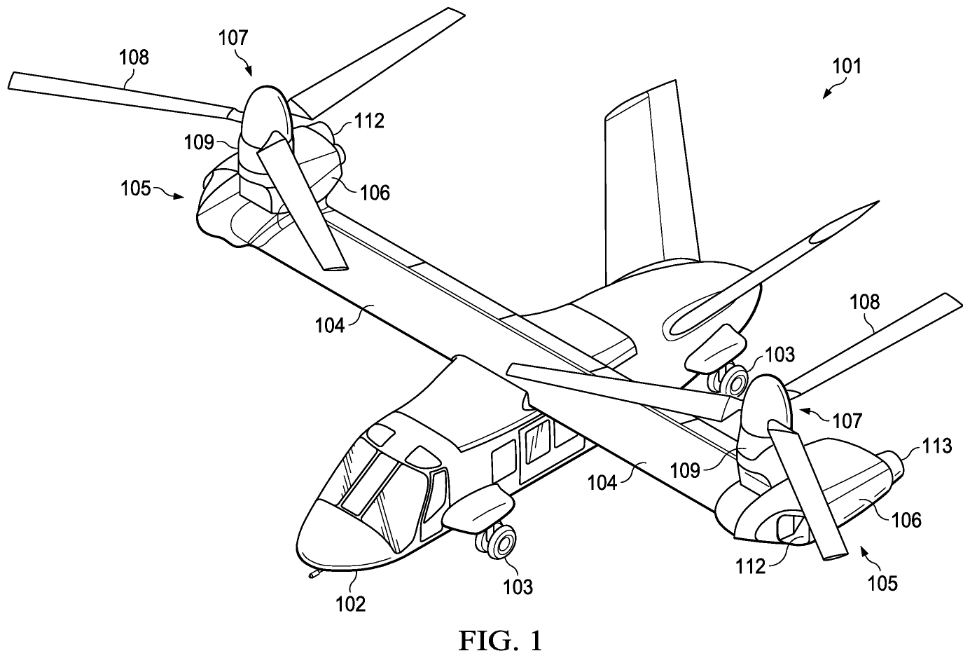

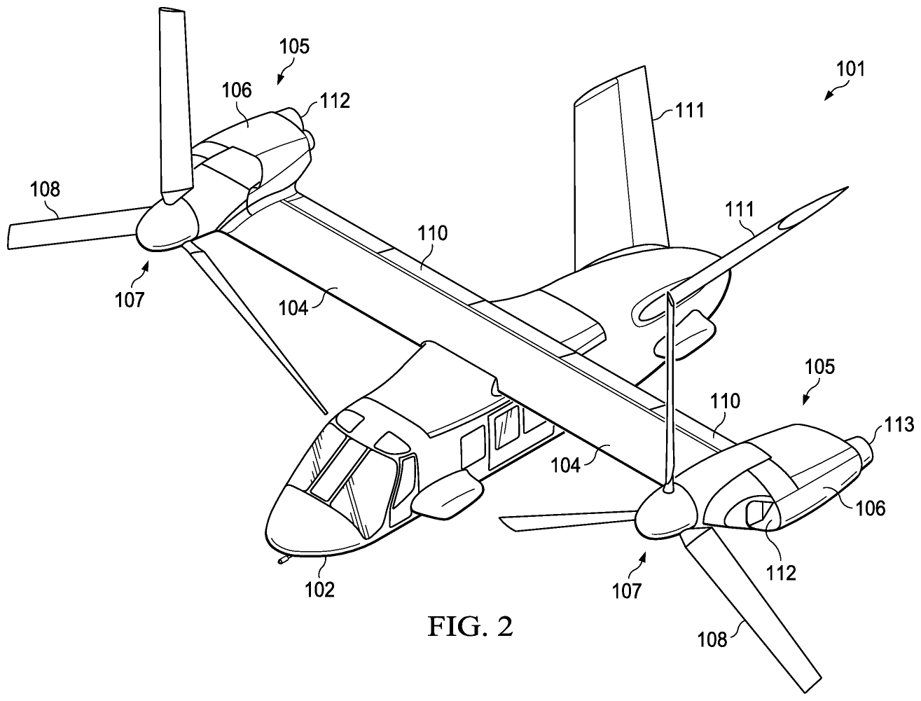

FIG. 1 illustrates a tiltrotor aircraft 101 in a helicopter mode wherein proprotors 108 are positioned substantially vertical to provide a lifting thrust. FIG. 2 illustrates tiltrotor aircraft 101 in an airplane mode wherein proprotors 108 are positioned substantially horizontal to provide a thrust for forward movement. The following discussion refers to the example embodiments shown in FIGS. 1 and 2. Tiltrotor aircraft 101 may include fuselage 102, landing gear 103, and wings 104. A propulsion system 105 is positioned on the ends of wings 104. Each propulsion system 105 includes an engine 106 and a proprotor 107 with a plurality of rotor blades 108. During operation, engines 106 typically maintain a constant rotational speed for their respective proprotors 108. The pitch of rotor blades 108 can be adjusted to selectively control thrust and lift of each propulsion system 105 on tiltrotor aircraft 101. The tiltrotor aircraft 101 includes controls, e.g., cyclic controllers and pedals, carried within a cockpit of fuselage 102, for causing movement of tiltrotor aircraft 101 and for selectively controlling the pitch of each blade 108 to control the direction, thrust, and lift of tiltrotor aircraft 101. For example, during flight a pilot can manipulate a cyclic controller to change the pitch angle of rotor blades 108 and/or manipulate pedals to provide vertical, horizontal, and yaw flight movement.

Propulsion system 105 includes a pylon 109 that is configured to rotate along with other rotatable pylon structure to improve aerodynamic airflow. Moveable pylon 109 can be mechanically coupled to an actuator system used for moving the proprotors 108 between airplane mode and helicopter mode. During the airplane mode, vertical lift is primarily supplied by the airfoil profile of wings 104, while rotor blades 108 provide forward thrust. During the helicopter mode, vertical lift is primarily supplied by the thrust of rotor blades 108. It should be appreciated that tiltrotor aircraft 101 may be operated such that propulsion systems 105 are selectively positioned between airplane mode and helicopter mode, which can be referred to as a conversion mode.

Control surfaces 110 on wing 104 are used to adjust the attitude of tiltrotor aircraft 101 around the pitch, roll, and yaw axes while in airplane or conversion mode. Additional stabilizers or control surfaces 111 may be required when tiltrotor aircraft 101 is in airplane mode. Control surfaces 110 and 111 may be, for example, ailerons, flaps, slats, spoilers, elevators, rudders, or ruddervators.

Propulsion system 105 for a tiltrotor aircraft 101 typically features a power train, drive shaft, hub, swashplate, and pitch links within pylon 109. The drive shaft and hub are mechanical components for transmitting torque and/or rotation from the engine 106 to the rotor blades 108. The power train may include a variety of components, including a transmission and differentials. In operation, the drive shaft receives torque or rotational energy from engine 106 and rotates the hub, which causes blades 108 to rotate about the drive shaft. A swashplate translates flight control input into motion of blades 108. Rotor blades 108 are usually spinning when tiltrotor aircraft 101 is in flight, and the swashplate transmits flight control input from the non-rotating fuselage 102 to the hub, blades 108, and/or components coupling the hub to blades 108 (e.g., grips and pitch horns).

FIGS. 1 and 2 show a propulsion system 105 in which engine 106 remains in a fixed position while proprotor 107, rotor blades 108, and pylon 109 rotate between the helicopter, conversion, and airplane modes. Each engine 106 has an inlet 112 to bring air into the engine compressor. The inlet 112 performance has a strong influence on engine net thrust. The exhaust gases from a fixed engine 106 are expelled through exhaust nozzle or tailpipe 113 in a rearward direction in all aircraft configurations. In other embodiments, the entire propulsion system 105, including engine 106, may rotate relative to wing 104. In such an embodiment, the inlet 112 and exhaust nozzle 113 would also rotate with engine 106. Exhaust gases would be expelled in a direction dependent on engine position and flight mode, such as rearward exhaust during airplane mode, downward exhaust in helicopter mode, and at an angle during conversion mode. Air may be forced toward engine inlet 112 by downwash from rotors 108 in some flight configurations. In airplane mode, free stream air also would be forced into engine inlet 112 by the forward movement of tiltrotor aircraft 101.

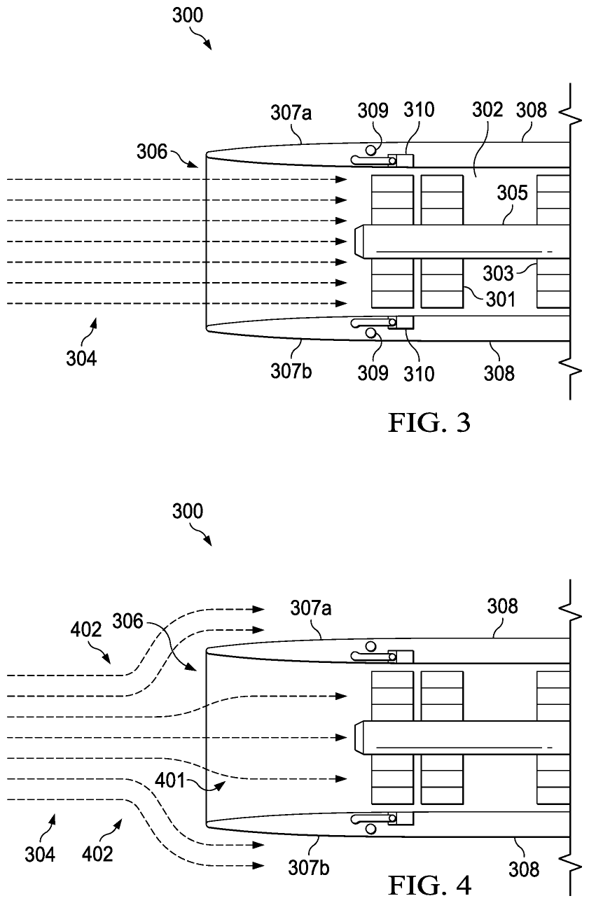

FIGS. 3, 4, and 5 depict cross-sections of an engine and aircraft system 300 illustrating different mass flow requirements and different inlet sizes. System 300 comprises a gas turbine engine having a compressor 301, combustion chamber 302, and compressor turbine 303. Inlet air 304 is taken into the compressor 301 and compressed to a high pressure. The compressed air is mixed with fuel and ignited, which produces high-pressure, high-velocity gas. This gas is used to turn the compressor turbine 303, which then powers the compressor 301 section via a coupling shaft 305. After passing through the compressor turbine 303, the gas is passed through a power turbine (not shown), and then expelled through an exhaust nozzle or tailpipe section. A power turbine shaft drives an accessory gearbox (not shown), which in turn drives accessories such as generators, hydraulic pumps, oil pumps, and the like. In a tiltrotor aircraft, the accessory gearbox also has a driveshaft that powers a main rotor gearbox (not shown). The main rotor gearbox drives the rotor system and turns the rotor blades to provide lift.

The geometry of the engine inlet 306 is determined by the size and position of engine intake walls 307a,b along with the top and bottom (not shown) of the engine inlet. FIG. 3 illustrates a case in which a high mass of inlet airflow 304 is required by engine and aircraft system 300. The geometry of engine inlet 306 is sized so that all of the free stream air 304 is ingested by system 300. This configuration minimizes aircraft drag and ensures that system 300 is operating at peak efficiency. The intake walls 307a,b are mounted on an engine shroud 308 with hinges 309. Actuators 310 control the position of intake walls 307a,b relative to engine shroud 308 by moving the intake walls 307a,b inward or outward, which has the effect of narrowing or enlarging the engine inlet 306. Actuators 310 may be, for example, any electrical, hydraulic, or pneumatic device that change the position of intake walls 307a,b in response to commands from a flight control computer or other processor.

FIG. 4 illustrates a case in which a low mass flow 401 is required by engine and aircraft system 300. The engine inlet 306 is sized so that system 300 attempts to ingest all of the free stream air 304; however, since engine and aircraft system 300 only needs air mass 401, there is excess air mass in free stream 304. This excess airflow 402 results in spillage drag that builds up in front of engine inlet 306 and pours over the intake walls 307a,b to run along the outside of engine shroud 308.

Spillage drag occurs when the forward-facing inlet duct 306 intakes more airflow than the engine compressor 301 can ingest at a given power setting. This excess airflow 402 spills back out of the inlet 306 into the free stream air and results in a drag penalty. While an engine inlet is often sized for maximum airflow conditions, which is typically during hover for a rotorcraft, this can result in significant spillage drag in other flight conditions and particularly at high speeds.

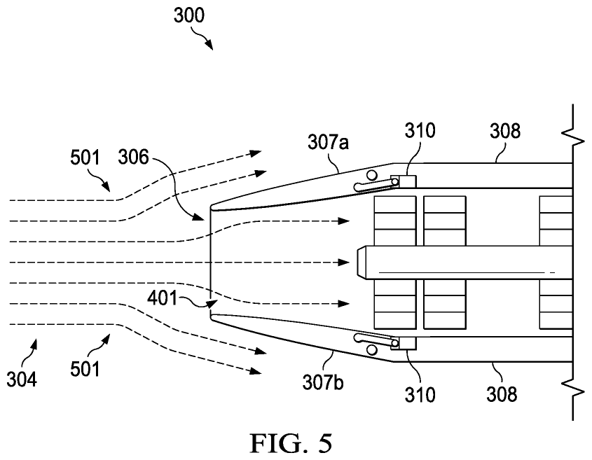

FIG. 5 illustrates engine and aircraft system 300 with intake walls 307a,b moved inward to narrow engine inlet 306 so that it is sized and configured to ingest low mass flow 401 and to guide excess air mass 501 outside of intake walls 307a,b so that it flows along the outside of engine shroud 308 in a more controlled aerodynamic fashion. Spillage drag is minimized by directing excess air mass 501 in this way. In one embodiment, an algorithm may be used to adjust the shape of the inlet geometry to minimize spillage drag. The algorithm may run on a flight control computer, for example, which controls actuators 310 to adjust intake walls 307a,b to a desired geometry for engine inlet 306.

Although FIGS. 3-5 illustrate a system 300 that adjusts the geometry of inlet 306 using moveable intake walls 307a,b, it will be understood that inlet geometry may be adjusted in other ways. For example, only one inlet wall 307a,b may be moved or the inlet walls 307a,b may be moved independently by differing amounts. In other embodiments, a top and/or bottom of the engine inlet may be moved in addition to, or in place of, moving intel walls 307a,b. Alternatively, rather than moving inlet walls 307a,b, ramps or vents inside engine inlet 306 may be adjusted to change the inlet geometry and the available path for airflow around engine and aircraft system 300.

In an embodiment, an algorithm utilizes aircraft parameters and existing models and relationships to determine the optimal inlet area to minimize spillage drag as a function of airspeed and engine power setting at the current ambient conditions, such as altitude and air temperature. Control over the inlet geometry provides improved aircraft performance in cruise flight, including specific fuel consumption (SFC), range, and maximum airspeed capability.

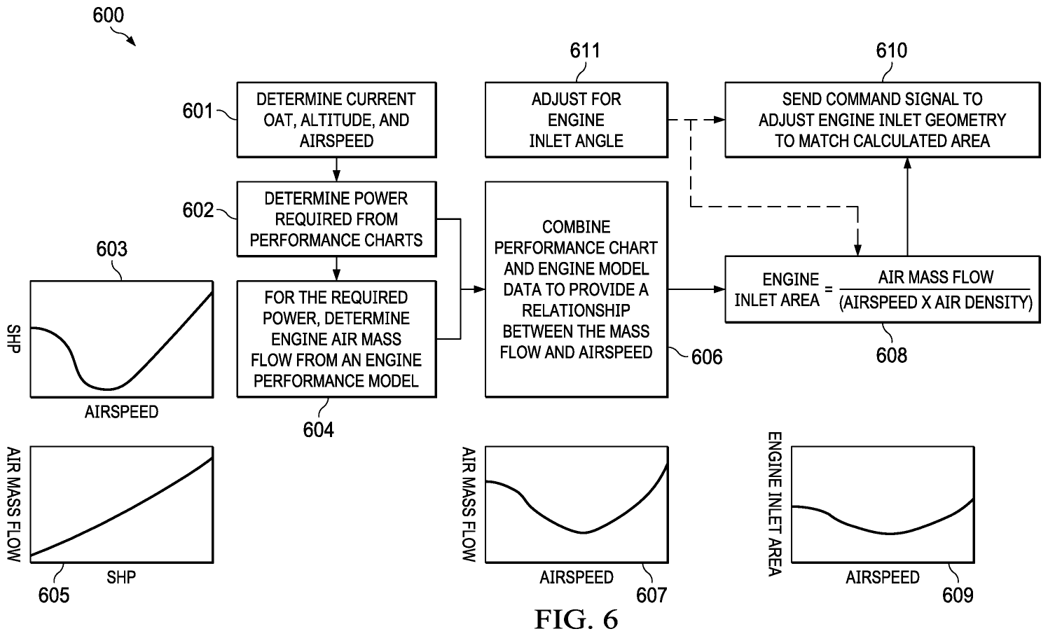

FIG. 6 is a flowchart illustrating an algorithm 600 for adjusting engine inlet geometry based upon flight conditions according to an example embodiment. The algorithm 600 may be embodied as computer instructions that are executed on a processor, such as a program executing in a flight control computer in an aircraft. In step 601, the flight control computer determines the current outside air temperature (OAT), altitude, and airspeed. This data may be collected from an aircraft's pitot-static system, temperature probes, and other sensors. In step 602, the engine power required for the current conditions is determined from aircraft performance charts. The performance charts may provide, for example, plots 603 of shaft horsepower (SHP) versus airspeed at different altitudes and OATs. The performance charts may be available in an aircraft or rotorcraft flight manual, for example, and the data from the charts may be stored in a table in the flight control computer's memory.

In step 604, for the required power as determined in step 602, the corresponding required engine air mass flow is determined from an engine performance model. The engine performance model may provide plots 605, for example, illustrating air mass flow versus SHP. The engine model may be a thermodynamic performance model from an engine manufacturer, for example, that predicts air mass flow for a specified power setting and for a given temperature, altitude, and airspeed. The engine performance model may take other factors into consideration, such as RPM, measured gas temperature (MGT), and/or exhaust gas temperature (EGT).

In step 606, the data from the performance charts 603 and the engine model 605 are combined to provide a relationship between the air mass flow and airspeed, such as plot 607. Knowing the current airspeed, the current air mass flow can be calculated as illustrated in plot 607. In step 608, the optimal engine inlet area may be calculated by dividing the air mass flow by the product of the airspeed and air density. The air density may be calculated by the flight control computer using the observed or estimated OAT, air pressure, and humidity, for example. The equation in step 608 may be used to create a plot 609 of engine inlet area versus airspeed for a particular air mass flow and air density.

In step 610, the flight control computer sends a command to adjust the engine inlet geometry to match the area calculated in step 608. The command may be, for example, a signal to an actuator 310 (FIG. 5) that forces an engine intake walls 307a,b to move. The flight control computer may have a stored table of data that equates different positions for engine intake walls 307a,b to various engine inlet areas. The flight control computer may then drive the actuators 310 to position engine intake walls 307a,b as required to meet the calculated geometry.

In some tiltrotor aircraft, the engine inlet rotates with the engine from a horizontal position facing into the airstream for airplane mode to a vertical position for hover in a helicopter craft mode. For aircraft in which the engine inlet rotates, in step 611 the flight control computer may adjust for the angle of the engine inlet relative to the airstream. The engine inlet area calculation in step 608 may be adjusted to compensate for the engine inlet angle, such as by modifying the required engine inlet area in proportion to a parameter based on the cosine of the engine inlet area. Alternatively, or additionally, the commands sent by the flight control computer to the engine inlet actuators may be modified in step 610 based upon the engine inlet angle and the calculated engine inlet area.

In an example embodiment, a method for controlling an aircraft engine inlet comprises determining a required engine power based upon current aircraft parameters, determining a desired engine air mass flow based upon the required engine power, calculating an optimum engine inlet area based upon the desired engine air mass flow, a current airspeed, and an air density, and providing a command to one or more actuators to adjust the aircraft engine inlet to conform to the calculated optimum engine inlet area. The aircraft parameters may comprise one or more of outside air temperature, altitude, airspeed, and humidity. The required engine power can be determined from aircraft performance chart data. The desired air mass flow can be determined from engine performance model data.

The method may further comprise determining a relationship between air mass flow and airspeed based upon the aircraft performance chart data and the engine performance model data.

The method may further comprise determining a current engine inlet angle, and calculating the engine inlet area based upon the current engine inlet angle.

The method may further comprise determining a current engine inlet angle, and adjusting the command to one or more actuators based upon the current engine inlet angle.

In an example embodiment, an aircraft comprises an engine having an inlet section with variable geometry, a flight control system configured to: determine a required engine power based upon current aircraft parameters, determine a desired engine air mass flow based upon the required engine power, calculate an optimum engine inlet area based upon the desired engine air mass flow, a current airspeed, and an air density, and provide a command to one or more actuators to adjust the inlet section geometry to conform to the calculated optimum engine inlet area. The optimum engine inlet area causes minimum spillage drag to optimize aircraft performance. The engine inlet section is configured to tilt between a helicopter mode position and an airplane mode position. The aircraft parameters may comprise one or more of outside air temperature, altitude, airspeed, and humidity. The required engine power may be determined from aircraft performance chart data. The desired engine air mass flow may be determined from engine performance model data.

The flight control system may be further configured to: determine a current engine inlet section angle, and calculate the optimum engine inlet area based upon the current engine inlet section angle.

The flight control system may be further configured to: determine a current engine inlet section angle; and adjust the command to one or more actuators based upon the current engine inlet section angle.

The flight control system may be further configured to: determine a relationship between engine air mass flow and airspeed based upon aircraft performance chart data and engine performance model data.

In an example embodiment, a flight control computer comprises one or more processors, and one or more computer-readable storage media having stored thereon computer-executable instructions that, when executed by the one or more processors, causes the processors to: determine a required engine power based upon current aircraft parameters, determine a desired engine air mass flow based upon the required engine power, calculate an engine inlet area based upon the desired engine air mass flow, a current airspeed, and an air density, and provide a command to one or more actuators to adjust the aircraft engine inlet to conform to the calculated engine inlet area. The computer-executable instructions may further cause the processors to: determine a relationship between engine air mass flow and airspeed based upon the aircraft performance chart data and the engine performance model data. The computer-executable instructions may further cause the processors to: determine a current engine inlet angle, and calculate the engine inlet area based upon the current engine inlet angle. The computer-executable instructions may further cause the processors to: determine a current engine inlet angle, and adjust the command to one or more actuators based upon the current engine inlet angle.

Embodiments of the present disclosure are not limited to any particular setting or application, and embodiments can be used with a rotor system in any setting or application such as with other aircraft, vehicles, or equipment. It will be understood that tiltrotor aircraft 101 is used merely for illustration purposes and that any aircraft, including fixed wing, rotorcraft, commercial, military, or civilian aircraft may use an engine-exhaust suppressor system as disclosed herein.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

What is claimed is:

1. A method for controlling an aircraft engine inlet, comprising:
determining a required engine power based upon current aircraft parameters;
determining a desired engine air mass flow based upon the required engine power;
calculating an optimum engine inlet area based upon the desired engine air mass flow, a current airspeed, and an air density; and
providing a command to one or more actuators to adjust the aircraft engine inlet to conform to the calculated optimum engine inlet area.

2. The method of claim 1, wherein the aircraft parameters comprise one or more of outside air temperature, altitude, airspeed, and humidity.

3. The method of claim 1, wherein the required engine power is determined from aircraft performance chart data.

4. The method of claim 1, wherein the desired air mass flow is determined from engine performance model data.

5. The method of claim 1, further comprising:
determining a relationship between air mass flow and airspeed based upon the aircraft performance chart data and the engine performance model data.

6. The method of claim 1, further comprising:
determining a current engine inlet angle; and
calculating the engine inlet area based upon the current engine inlet angle.

7. The method of claim 1, further comprising:
determining a current engine inlet angle; and
adjusting the command to one or more actuators based upon the current engine inlet angle.

8. An aircraft, comprising:
an engine having an inlet section with variable geometry;
a flight control system configured to:
determine a required engine power based upon current aircraft parameters;
determine a desired engine air mass flow based upon the required engine power;
calculate an optimum engine inlet area based upon the desired engine air mass flow, a current airspeed, and an air density; and
provide a command to one or more actuators to adjust the inlet section geometry to conform to the calculated optimum engine inlet area.

9. The aircraft of claim 8, wherein the optimum engine inlet area causes minimum spillage drag to optimize aircraft performance.

10. The aircraft of claim 8, wherein the engine inlet section is configured to tilt between a helicopter mode position and an airplane mode position.

11. The aircraft of claim 10, wherein the flight control system is further configured to:
determine a current engine inlet section angle; and
calculate the optimum engine inlet area based upon the current engine inlet section angle.

12. The aircraft of claim 10, wherein the flight control system is further configured to:
determine a current engine inlet section angle; and
adjust the command to one or more actuators based upon the current engine inlet section angle.

13. The aircraft of claim 8, wherein the aircraft parameters comprise one or more of outside air temperature, altitude, airspeed, and humidity.

14. The aircraft of claim 8, wherein the required engine power is determined from aircraft performance chart data.

15. The aircraft of claim 8, wherein the desired engine air mass flow is determined from engine performance model data.

16. The aircraft of claim 8, wherein the flight control system is further configured to:
determine a relationship between engine air mass flow and airspeed based upon aircraft performance chart data and engine performance model data.

17. A flight control computer, comprising:
one or more processors;
one or more computer-readable storage media having stored thereon computer-executable instructions that, when executed by the one or more processors, causes the processors to:
determine a required engine power based upon current aircraft parameters;
determine a desired engine air mass flow based upon the required engine power;
calculate an engine inlet area based upon the desired engine air mass flow, a current airspeed, and an air density; and
provide a command to one or more actuators to adjust the aircraft engine inlet to conform to the calculated engine inlet area.

18. The flight control computer of claim 17, wherein the computer-executable instructions further cause the processors to:
determine a relationship between engine air mass flow and airspeed based upon the aircraft performance chart data and the engine performance model data.

19. The flight control computer of claim 17, wherein the computer-executable instructions further cause the processors to:
determine a current engine inlet angle; and
calculate the engine inlet area based upon the current engine inlet angle.

20. The flight control computer of claim 17, wherein the computer-executable instructions further cause the processors to:
determine a current engine inlet angle; and
adjust the command to one or more actuators based upon the current engine inlet angle.
